(19) United States
(12) Patent Application Publication
(10) Pub. No.: US 2026/0057249 A1
(43) Pub. Date: Feb. 26, 2026

(54) INTERMEDIATE REPRESENTATION HIGHERING FOR TENSOR-LIKE COMPUTATIONS

(71) Applicant: NEC Laboratories Europe GmbH, Heidelberg (DE)

(72) Inventor: Nicolas WEBER, Heidelberg (DE)

(21) Appl. No.: 19/106,237

(22) PCT Filed: May 31, 2023
(86) PCT No.: PCT/IB2023/055585

§ 371 Date: Feb. 25, 2025

(30) Foreign Application Priority Data
Nov. 30, 2022 (EP) 22210548

(51) Int. Cl. G06N 3/0985; G06N 3/042

(52) U.S. Cl. CPC G06N 3/0985; G06N 3/042

(57) ABSTRACT

A method for intermediate representation highering includes detecting one or more types of higherable operations associated with one or more extracted sub-graphs or one or more hyperparameters within the one or more extracted sub-graphs. The one or more extracted sub-graphs are part of a computational graph associated with a first intermediate representation (IR) during a compiling process for converting source code to machine code. The method further includes replacing the one or more extracted sub-graphs with one or more higher level layers indicated by the higherable operations to generate a new computational graph.

### CROSS-REFERENCE TO PRIOR APPLICATION

This application is a U.S. National Phase application under 35 U.S.C. § 371 of International Application No. PCT/IB2023/055585, filed on May 31, 2023, and claims benefit to European Patent Application No. EP22210548.8, filed on Nov. 30, 2022, the entire contents of which is hereby incorporated by reference herein. The International Application was published in English on Jun. 6, 2024 as WO 2024/115972 A1 under PCT Article 21 (2).

### FIELD

The present invention relates to a method, system and computer-readable medium for “intermediate representation highering”, which relates to reconstructing high level operators from a lower-level implementation that enables high level optimizations on low level intermediate representation (IR) inputs.

### BACKGROUND

Modern compilers and runtime systems use various levels of abstractions to represent computations. Low level virtual machine (LLVM) Intermediate Representation (IR) is the lowest level of IR used in LLVM-based compilers. However, LLVM IR is too low level to apply high level computational transformations. For instance, mathematical optimizations such as rectified linear unit (ReLU) are difficult to implement on low-level IRs. For example, mathematical optimizations such as “ReLU→MaxPooling (min_value=−inf)=MaxPooling (min_value=0)”, which can represent an activation function and/or pooling operations, are difficult to implement on low-level IRs such as LLVM IRs. Thus, Multi-Level Intermediate Representation (MLIR) was introduced as an extension to LLVM IR that enables to add more high-level abstraction layers on top. Therefore, mathematically optimization can be implemented on the higher levels. Then, the higher level can be lowered to the next lower one, which adds more and more implementation details, such as parallelization or vectorization strategies.

However, an issue with this “lowering” process (e.g., moving from a higher IR to a lower IR) is that it is unidirectional. In other words, using traditional methods and approaches, it is only possible to stay either on the same IR level, or convert it into a lower IR, but never up. This might not be problematic if the high level IRs are feature complete. However, for certain applications, such as compilation of recurrent neural networks (RNN), the “lowering” processing being unidirectional presents significant issues.

### SUMMARY

In an embodiment, the present disclosure provides a method for intermediate representation highering. One or more types of higherable operations associated with one or more extracted sub-graphs or one or more hyperparameters within the one or more extracted sub-graphs is detected. The one or more extracted sub-graphs are part of a computational graph associated with a first intermediate representation (IR) during a compiling process for converting source code to machine code. Further, the one or more extracted sub-graphs are replaced with one or more higher level layers indicated by the higherable operations to generate a new computational graph.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 shows graphs describing unfold and fold operations according to an embodiment of the present disclosure;

FIG. 2 illustrates a simplified block diagram depicting an exemplary system according to an embodiment of the present disclosure;

FIGS. 3A-3B show the highering process for a RNN layer according to an embodiment of the present invention;

FIGS. 4A and 4B show examples for mathematically equivalent subgraphs according to an embodiment of the present invention; and

FIG. 5 is a block diagram of an exemplary processing system, which can be configured to perform any and all operations disclosed herein.

### DETAILED DESCRIPTION

Modern compilers and runtime systems use various levels of abstractions to represent computations. LLVM IR is the lowest level of IR used in LLVM-based compilers. However, LLVM IR is too low level to apply to high level computational transformations. MLIR was introduced as an extension to LLVM IR that enables to add more high-level abstraction layers on top. Thus, mathematical optimization can be implemented on the higher levels. Then, the higher level can be lowered to the next lower one, which adds more and more implementation details, such as parallelization or vectorization strategies.

For example, the LLVM-based compiler Implicit Single Program Multiple Data (SPMD) Program Compiler (ISPC) uses its own ISPC C-style language (e.g., can be referred to as ISPC-IR), which gets lowered into low-level LLVM IR. By doing so, it automatically adds vectorization information that it derives from code annotations within their C-style language. In ISPC, the user only specifies which variables are to be vectorized, and then ISPC enhances this information with specialized instructions for Advanced Vector Extension (AVX) instruction sets such as AVX2 or AVX512, performs loop unrolling, and so on.

Example code for sum reduction implemented in ISPC's specialized C-dialect that enables ISPC to annotate LLVM-IR with vectorization hints is provided:

varying float accumulator = 0.0f; // vector float register
foreach(idx = 0 ... 512) { // vectorized loop
accumulator += input[idx]; // vectorized access to ‘input‘, as idx is a vector loop index
}
uniform float result = reduce_add(accumulator); // vector reduction to gain final scalar result

Other examples are TORCHSCRIPT or TENSORFLOW Graph, which are high-level tensor-computation IRs that can be lowered to an MLIR dialect, which finally results in LLVM IR.

The problem of this “lowering” process is that it is unidirectional. It is only possible to stay either on the same IR level, or convert it into a lower IR, but never up. This might not be problematic if the high level IRs are feature complete. This can also depend on the IR. For instance, in some examples such as KERAS, the user programs can be: “layer=keras.layers.SimpleRNN ( . . . )”. In terms for SimpleRNN, this IR is feature complete. However, if it then gets translated in TENSORFLOW Graph, the TENSORFLOW Graph might not know and/or understand the RNN layers, so the SimpleRNN gets translated into separate instructions that perform the identical mathematical computations. Explicitly, it can be translated into:

$$I = MatMul ( Input , InputWeights )$$

$$H = MatMul ( HiddenState , HiddenWeights )$$

$$X = I + H + Bias$$

$$Output = Activation ( X )$$

Thus, if applying optimizations on the TENSORFLOW Graph, much more complicated steps may need to be performed because the single instruction in KERAS, became multiple ones in TENSORFLOW Graph. In other words, while problems might not be encountered doing optimizations on KERAS, the first step needed is to detect the Simple RNN within the TENSORFLOW Graph. This can be akin to natural language, where some languages do not have words for specific terms. In natural language, the foreign language word can be used, but this is not possible in IRs. Therefore, embodiments of the present invention can be used.

One example where the lowering process being unidirectional is problematic is for Recurrent Neural Network (RNN) layers. In principle, these layers can be represented as a graph of General Matrix Multiply (GEMM), Multiply (Mul), Add, Scatter, Gather, Concatenation (Concat), Sigmoid, and hyperbolic tangent (Tanh) functions, operations, and/or layers. However, libraries such as NVIDIA CUDA Deep Neural Network (CUDNN) or Deep Neural Network Library (DNNL) provide highly efficient vendor-optimized implementations for RNN layers that can significantly outperform even specialized compiled implementations that rely on compositions of single layers (e.g., 2-4× speedup is realistic for today's state-of-the-art machine learning (ML) compilers).

While PYTORCH supports high-level RNN layers in their IR (e.g., TORCHSCRIPT), TENSORFLOW does not support such a layer in their IR (TENSORFLOW Graph), and instead implements them as composition of layers. This results not only in different low-level representations of the same neural network implemented within these two frameworks, but also prevents the underlying compiler and runtime systems to use the optimized RNN implementations of computation libraries.

Another example is when using the Unfold and Fold operations (often also called “im2col” and “col2im”). The code for the Unfold and Fold operations are shown below.

$$x = unfold ( x , kernel\_size , dilation , padding , stride )$$

$$x = gemm ( x , weight )$$

$$x = fold ( x , output\_size , kernel\_size , dilation , padding , stride )$$

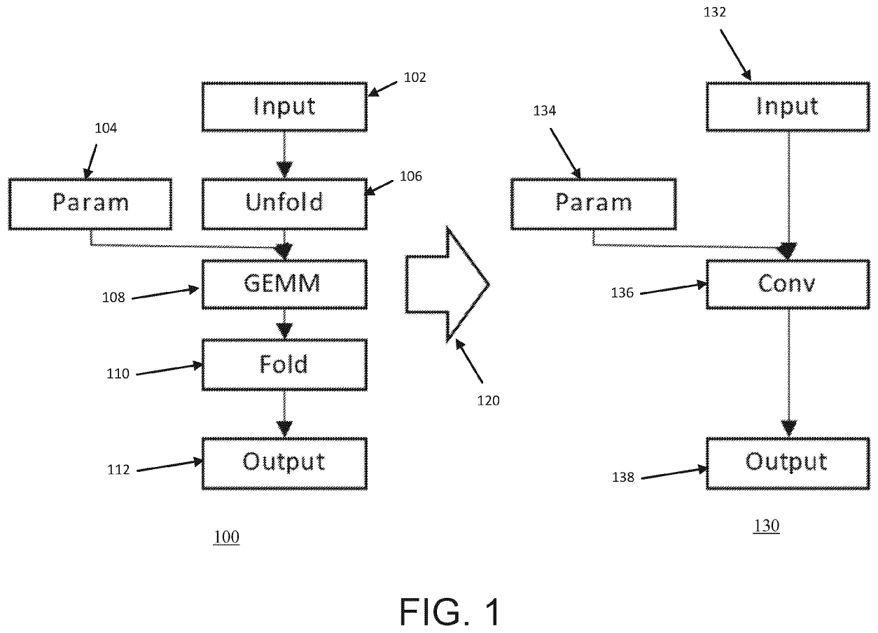

The series of three layers represents a low-level implementation of a convolution layer. However, as it uses lower-level primitives, the compiler cannot use the higher-level convolution implementations from optimized libraries. FIG. 1 shows this as two graphs (e.g., computational graphs). For instance, FIG. 1 shows graphs 100 and 130 describing unfold and fold operations according to an embodiment of the present invention. For instance, graph 100 shows a computational graph for the fold and unfold operations (e.g., the above code). For instance, input 102 is provided to an unfold block 106. The output of the unfold block 106 and the parameters (“Param”) 104 are provided to the GEMM block 108. The output of the GEMM block 108 is provided to the fold block 110. The output of the fold block 110 is provided as output 112. The graph 100 is a low-level implementation of a convolution layer, and the graph 130 is a computational graph for the convolution layer. Arrow 120 shows this relationship between graphs 100 and 130. Referring to computational graph 130, the input 132 and the parameters 134 are provided to the convolutional block 136. The output of the convolutional block 136 is provided as output 138.

Similarly, computing convolutions can also be performed within the frequency domain using Fast Fourier Transformations (FFT). The below code shows the convolution computation in the frequency domain:

$$x = fft ( x )$$

$$y = fft ( weight )$$

$$x = gemm ( x , y )$$

$$x = ifft ( x )$$

In general, this can apply to situations where nowadays very complex operations are encapsulated in specialized operators, such as (but not limited to) RNN, FFT, and/or convolutions, but also basic blocks such as GEMM could be implemented using Broadcast, multiply (Mul) and summation (Sum) layers.

Accordingly, embodiments of the present invention solve the transformation of low-level computational graphs to higher-level computational graphs. For instance, embodiments of the present invention provide a system and method to reconstruct high level operators from a lower-level implementation, that enables high level optimizations on low level IR inputs. By using embodiments of the present invention (e.g., reconstructing high level operators), substantial improvements to a functioning of a computer (e.g., a compiler being executed on a computer) is achieved. For instance, using embodiments of the present invention, it was determined that the compiling speed for a smaller RNN was increased by a factor of approximately 17 times when compared to conventional methods, and the amount of energy saved (e.g., the reduction of energy used) was approximately 8 times the amount of energy of conventional methods. When being used on an even larger RNN network, the results show a speed-up of 50 times when compared to conventional methods. Furthermore, by using embodiments of the present invention, specific and specialized hardware are able to be used during the compilation process.

According to a first aspect, the present disclosure provides a method for intermediate representation highering. One or more types of higherable operations associated with one or more extracted sub-graphs or one or more hyperparameters within the one or more extracted sub-graphs is detected. The one or more extracted sub-graphs are part of a computational graph associated with a first intermediate representation (IR) during a compiling process for converting source code to machine code. The method further includes replacing the one or more extracted sub-graphs with one or more higher level layers indicated by the higherable operations to generate a new computational graph.

According to a second aspect, the method according to the first aspect further comprises that the compiling process comprises sequentially using each of a plurality of IRs one after another to convert the source code to the machine code and the one or more higher level layers is associated with a second IR that is sequentially before the first IR within the plurality of IRs during the conversion from the source code to the machine code.

According to a third aspect, the method according to the first or the second aspect further comprises preprocessing the first IR to identify the one or more extracted sub-graphs that indicate the one or more higher level layers based on using a bottom-up search.

According to a fourth aspect, the method according to the third aspect further comprises that preprocessing the first IR to identify the one or more extracted sub-graphs that indicate the one or more higher level layers comprises parsing through the computational graph to detect a potential higher level layer or an end-node of the potential higher level layer and performing reverse parsing of the computational graph based on detecting the potential higher level layer or the end-node.

According to a fifth aspect, the method according to the fourth aspect further comprises that preprocessing the first IR to identify the one or more extracted sub-graphs that indicate the one or more higher level layers comprises aborting the reverse parsing based on passing a layer that cannot be part of the potential higher level layer or aborting the reverse parsing based on comparing a number of layers parsed during the reverse parsing and a maximum possible of layer threshold.

According to a sixth aspect, the method according to any of the first to fifth aspects further comprises that detecting the one or more types of higherable operations associated with one or more extracted sub-graphs or the one or more hyperparameters within the one or more extracted sub-graphs comprises determining a traversed structure for a sub-graph, of the one or more extracted sub-graphs, based on counting a number and type of layers being passed when traversing the sub-graph and excluding one or more second higherable operations based on the traversed structure of the sub-graph not matching structures for the one or more second higherable operations.

According to a seventh aspect, the method according to the sixth aspect further comprises that detecting the one or more types of higherable operations associated with the one or more extracted sub-graphs or the one or more hyperparameters within the one or more extracted sub-graphs comprises determining a higher level layer, of the one or more higher level layers, for the sub-graph based on the traversed structure of the sub-graph matching the structure for the one or more types of higherable operations and/or the one or more hyper-parameters passed when traversing the sub-graph.

According to an eighth aspect, the method according to any of the first through seventh aspects further comprises applying one or more optimization techniques to the one or more higher level layers of the new computational graph to facilitate the compiling process for converting the source code to the machine code.

According to an ninth aspect, the method according to the eighth aspect further comprising that the one or more optimization techniques comprises using specialized hardware and/or one or more optimization libraries.

According to an tenth aspect, the method according to the ninth aspect further comprising that the specialized hardware is unable to use the computational graph associated with the first IR, and based on replacing the one or more extracted sub-graphs with the one or more higher level layers, the specialized hardware uses the new computational graph during the compiling process.

According to an eleventh aspect, the method according to any of the first through tenth aspects further comprising that replacing the one or more extracted sub-graphs with the one or more higher level layers to generate the new computational graph comprises during translating the first IR to a destination IR, replacing the one or more extracted sub-graphs in place with the one or more higher level layers to generate the new computational graph.

According to an twelfth aspect, the method according to any of the first through tenth aspects further comprising that replacing the one or more extracted sub-graphs with the one or more higher level layers to generate the new computational graph comprises during translating the first IR to a destination IR, replacing the one or more extracted sub-graphs out-of-place with the one or more higher level layers to generate the new computational graph.

According to a thirteenth aspect, the method according to any of the first through twelfth aspects further comprising prior to detecting the one or more types of higherable operations associated with one or more extracted sub-graphs or the one or more hyperparameters within the one or more extracted sub-graphs, transforming basic operations within the computational graph associated with the first IR.

According to a fourteenth aspect of the present disclosure, a system for intermediate representation highering is provided, the system comprising one or more hardware processors, which, alone or in combination, are configured to provide for execution of the following steps: detecting one or more types of higherable operations associated with one or more extracted sub-graphs or one or more hyperparameters within the one or more extracted sub-graphs and replacing the one or more extracted sub-graphs with one or more higher level layers indicated by the higherable operations to generate a new computational graph. The one or more extracted sub-graphs are part of a computational graph associated with a first intermediate representation (IR) during a compiling process for converting source code to machine code.

A fifteenth aspect of the present disclosure provides a tangible, non-transitory computer-readable medium having instructions thereon, which, upon being executed by one or more processors, provides for execution of the method according to any of the first to the thirteenth aspects.

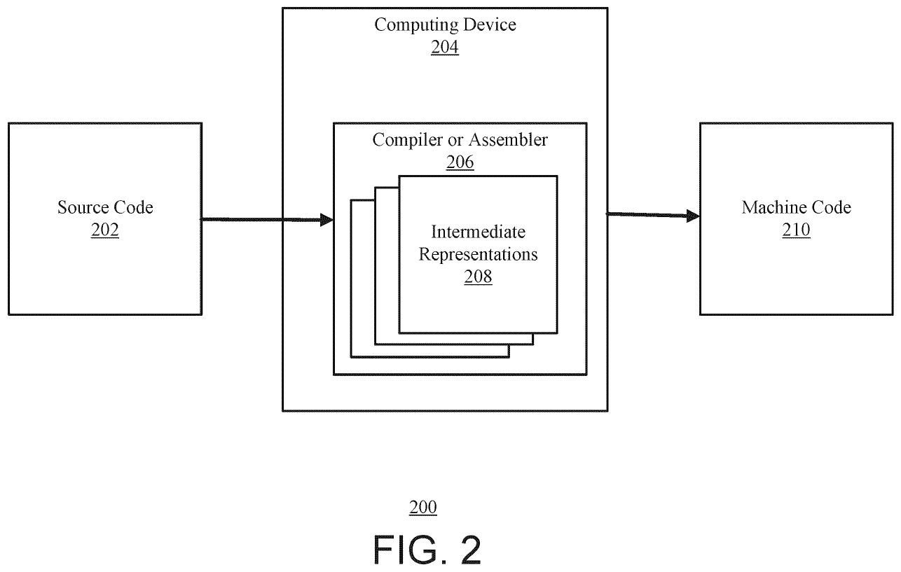

FIG. 2 illustrates a simplified block diagram depicting an exemplary system according to an embodiment of the present disclosure. For instance, FIG. 2 shows source code 202, a computing device 204, and machine code 210. The computing device 204 includes a compiler or assembler 206, which further includes and/or utilizes one or more intermediate representations 208 such as an intermediate representation that provides for the transformation of low-level computational graphs to higher-level computational graphs (e.g., reconstructing high level operators from a lower-level implementation, that enables high level optimizations on low level IR inputs).

For instance, the computing device 204 obtains source code 202. The source code 202 can be any collection of text, with or without comments, written using a programming language (e.g., a human-readable programming language), which can facilitate the work of humans (e.g., computer programmers). For instance, the source code 202 can include code related to executing an RNN (e.g., one or more RNN layers). The computing device 204 outputs machine code 210 using a compiler or assembler 206. For instance, the machine code 210 is computer code indicating machine language instructions that are used to control a computer's processor (e.g., a central processing unit (CPU)). The compiler or assembler 206 is a computer program that translates the computer code from one language (e.g., the language of the source code 202) to another language (e.g., the language of the machine code 210). In other words, the compiler or assembler 206 transforms or converts the source code 202 to the machine code 210. In some examples, the source code 202 can also be machine code. For instance, the source code 202 can be machine code (e.g., first machine code) that is different from the machine code 210 (e.g., second machine code). The compiler or assembler 206 can convert from the first machine code to the second machine code (e.g., first machine code such as the source code 202->assembler->LLVM-IR->MLIR->TENSORFLOW Graph->the second machine code 210 such as KERAS).

In some instances, the compiler or assembler 206 uses intermediate representations 208. Intermediate representations (IRs) 208 is a data structure or code that is used internally by a compiler, assembler, and/or virtual machine (e.g., the compiler or assembler 206) to represent intermediate source code. IRs are used to enable the compiler or assembler 206 to break up the conversion of the source code 202 to the machine code 210 into multiple phases and/or components, which allows for optimization and elimination of the need for a new compiler for every unique machine and source code (e.g., multiple types of source code, such as source code in different programming languages, can be compiled and processed by multiple types of hardware such as different types of CPUs using IRs). The beginning stages of the IRs (e.g., the IRs that are processing and/or closer to the source code 202) are the higher levels of the IRs, and the end stages of the IRs (e.g., the IRs that are processing and/or closer to the machine code 210) are the lower levels of the IRs. As mentioned above, the lowest level of the IR can be the LLVM-IR. For instance, for LLVM based compilers, the lowest level of IR can be the LLVM-IR. In other embodiments (e.g., for other compilers such as “GNU not Unix!” (GNU) Compiler Collection (GCC)), the lowest level of IR can be other types of IRs.

Therefore, throughout the processing of the IRs by the compiler or assembler 206 of the computing device 204, at each stage of level, the computing device 204 continuously breaks the source code 202 into lower level code that represents closer to the machine code 210. As mentioned above, during the “lowering” process (e.g., from a higher level of IR to a lower level of IR), the process is unidirectional, which indicates that the computing device 204 can stay on the same IR level, or convert the code into a lower IR level, but never up. As such, embodiments of the present invention utilize a method for transforming low-level computational graphs for lower level IRs to higher-level computational graphs (e.g., reconstructing high level operators from a lower-level implementation, which enables high level optimizations on low level IR inputs). For instance, by transforming low-level computational graphs to higher-level computational graphs, the computing device 204 is able to utilize optimization techniques (e.g., utilizing libraries such as CUDNN or DNNL and/or specific or specialized hardware) to reduce memory usage, reduce the amount of energy or power utilized by the computing device 204, and/or speed-up the processing of the source code 202.

The computing device 204 is any type of computing device that can compile code. For instance, the computing device 204 is and/or includes, but is not limited to, a desktop, laptop, tablet, mobile device (e.g., smartphone device, or other mobile device), one or more processors (e.g., a central processing unit (CPU)), server, cloud computing platform, computing system and/or other types of computing entities that generally comprises one or more communication components, one or more processing components, and/or one or more memory components. In some instances, the computing device 204 is connected to another computing device. For instance, the computing device 204 can be a CPU that is connected to a graphics processing unit (GPU).

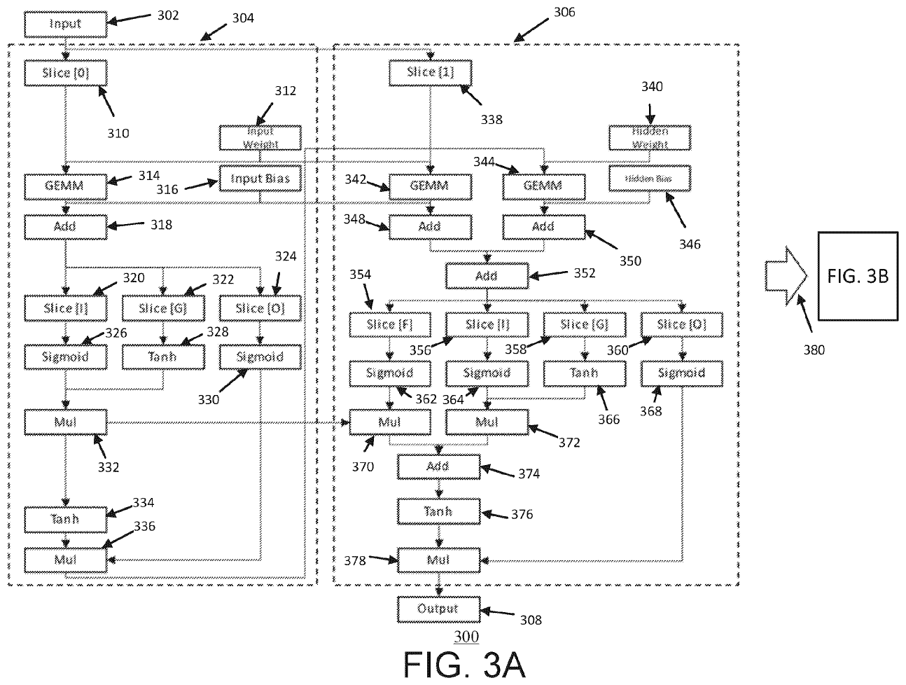

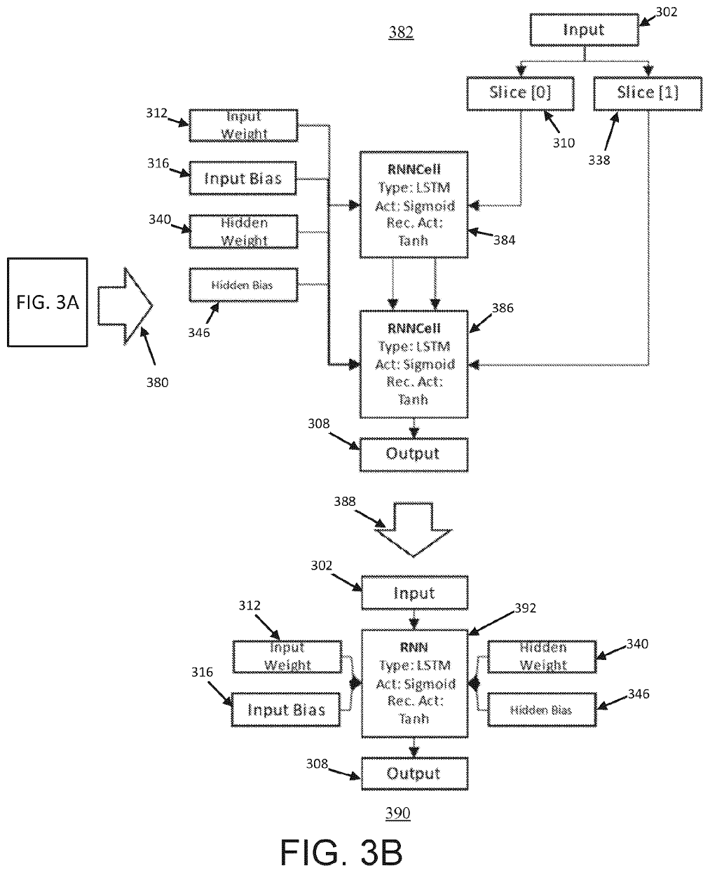

FIGS. 3A-3B show the highering process for a RNN layer according to an embodiment of the present invention. FIGS. 3A-3B show computational graphs 300, 382, and 390. For instance, referring to FIG. 3A, as shown, the RNN layer is much more complicated than for the convolution case (e.g., FIG. 1). Each dashed box 304 and 306 indicates a so called RNN Cell. For instance, the dashed box 304 shows a first RNN Cell and the dashed box 306 shows a second RNN cell. The RNN Cell is the inner most building block of a RNN layer. The first problem arises, that although both perform the same operation, they look different. For instance, the left one (e.g., the first RNN cell 304) misses the entire “Slice [F]” sub-graph 354, the GEMM using the “Hidden Weight” 344, Add using the “Hidden Bias” 350 and has additional Mul 372 and Add 374 in the lower part. This is caused by the fact, that no hidden-state is provided to the first RNN Cell 304, while it gets passed onto from the first to the second one (e.g., from the first RNN Cell 304 to the second RNN Cell 306). This will be described in further detail below.

In other words, embodiments of the present disclosure solve how to transform low-level computation graphs (e.g., the computational graph 300 shown in FIG. 3A) to high-level computation graphs (computational graphs 382 and 390 of FIG. 3B).

For instance, referring to FIG. 3A, the first RNN cell 304 includes blocks 310-366 such as the “Slice [0]” block 310, the input weight 312, the input bias 316, the GEEM 314, the ADD 314, the Sigmoids 326 and 330, the Tanh 328, the Mul 332, and others. The second RNN cell 306 includes blocks 338-378 such as the hidden weight 340, the hidden bias 346, and other blocks. Referring to the arrow 380 from FIGS. 3A and 3B, the arrow 380 shows the transformation of the computational graph 300 into the computational graph 382. For instance, the computational graph 382 shown in FIG. 3B includes similar blocks to computational graph 300, but certain blocks from the computational graph 300 are consolidated into RNNCell blocks 384 and 386. For instance, certain blocks from the first RNN Cell 304 are consolidated into RNNCell block 384 and certain blocks from the second RNN Cell 306 are consolidated into RNNCell block 386. These cells 384 and 386 are Type: long short-term memory (LSTM), activation (“Act”): Sigmoid, and recurrent activation (“Rec. Act”): Tanh. Further, the arrow 388 denotes the change from computational graph 382 to computational graph 390. For instance, the RNNCells 384 and 386 are consolidated into block RNN 392. The consolidation and conversion of the computational graph 300 to 382 to 390 will be described in further detail below.

In some instances, “Slice” blocks (e.g., the “Slice [0]” block 310) takes only a portion of the provided input data (e.g., if there is a tensor with size 10, and a tensor [2:4] is performed, then elements 2 and 3 are extracted, and this new tensor is provided with size 2). The input weight block (e.g., input weight 312) is “I=MatMul (Input, InputWeights)”. The hidden bias 346 is the same just for the hidden state. The input bias 316 is “x=y+broadcast (Bias)” and/or “x=y+Bias”. Thus, the following example is provided:

$$InputWeightblock ≫ I = MatHul ( Input , InputWeights )$$

$$HiddenWeightBlock ≫ H = MatMul ( HiddenState , HiddenWeights )$$

$$InputBiasBlock ≫ X = I + InputBias$$

$$HiddenBiasBlock ≫ Y = H + HiddenBias$$

As used herein, “==” represents equal or similar to and the following mapping of terminology is used:

$$Computation Graph ( CG ) == Intermediate Representation ( IR ) = Neural Network ( NN )$$

$$Layer == Operation == Primitive == Operator$$

Modern compilers and runtime systems use various level of abstractions to represent computations. With MLIR, a multi-level IR for the LLVM-compiler-ecosystem was established that allows to have multiple levels of abstractions. This multi-level approach allows to use few details on high levels and when lowering to a lower level, to add more and more implementation details. Embodiments of the present invention provide a method to reconstruct high level operators from a lower-level implementation, that enables high level optimizations, on low level IR inputs.

For example, embodiments of the present invention provide an automated detection of high-level operators within a low-level IR. For this, the computing device 204 uses a higher level IR that supports the higher-level primitives and a mechanism to convert the source IR to the destination IR. Either while parsing the source IR (or in a separate step after conversion), the computing device 204 analyzes the graph (e.g., the computational graph). Each of these “higherable” operations has a specific mathematical scheme that can be detected. The “higherable” operations can be any operation that can be decomposed into lower-level instructions. Some examples are Convolution or RNN. Other examples can also be a general matrix multiply (GEMM)/matrix multiplication (MatMul) (e.g., GEMM/MatMul), which can be represented as Broadcast, Sum and Reduce. For instance, example code for the RNN is provided below, which relates to the computational graphs from FIGS. 3A-3B. To increase readability, certain hyper-parameters such as kernel, dilation, and so on in the below example code have been omitted (Scheme: HighLevel-IR>>Low Level-IR). Further, “int” stands for any positive integer value. For instance, the “Scheme” indicates that a Higher-Level Operation (e.g., “SimpleRNN (ReLU, with_bias)”) can be represented as “relu(add(gemm(Input, Weights), Bias))”. Thus, if the lower level IR (e.g., “relu(add(gemm(Input, Weights), Bias))”) is detected within the IR, the lower level IR can be replaced with the Higher Level Operation (e.g., “SimpleRNN (ReLU, with_bias)”). Another example can be “Output=scale (Input, Weight, Bias)>>Output=Input*Weight+Bias” with the first (e.g., Output=scale (Input, Weight, Bias)) being the higher level and the second (e.g., Output=Input*Weight+Bias) being the lower level representation. The example code is provided below:

# RNNs
SimpleRNN(ReLU, with_bias) >> relu(add(gemm(Input, Weights), Bias))
SimpleRNN(ReLU, no_bias) >> relu( gemm(Input, Weights) )
SimpleRNN(Tanh, no_bias) >> tanh( gemm(Input, Weights) )
Possible Hyperparameters:

| | |
|---|---|
| Masking | = [True, False] |
| Bias | = [True, False] |
| Direction | = [Left2Right, Right2Left, Bidirectional_Sum, Bidirectional_Concat] |
| RNNType | = [SimpleRNN, LSTM, GRU, LBR_GRU, ...] # any kind of RNN layer |
| Activation | = [Sigmoid, ReLU, Tanh, ...] # any kind of activation function |

RecurrentActivation = ... # see activation

| | |
|---|---|
| Dropout | = [0.0-1.0) |
| RecurrentDropout | = [0.0-1.0) |
| InputChannels | = int |
| HiddenChannels | = int |
| NumSequences | = int |
| NumLayers | = int |

# Convolutions
Conv(with_bias) = add(fold(mul(unfold(Input), Weights)), Bias)
Conv(no_bias) = fold(mul(unfold(Input), Weights))
Possible Hyperparameters:

| | |
|---|---|
| KernelSize | = Tuple[int] |
| Dilation | = Tuple[int] |
| Stride | = Tuple[int] |
| LeftPadding | = Tuple[int] |
| RightPadding | = Tuple[int] |
| Bias | = [True, False] |
| InputChannels | = int |
| OutputChannels | = int |

# GEMMs
GEMM(with_bias) = add(sum(mul(expand(x), Weight)), Bias)
GEMM(no_bias) = sum(mul(expand(x), Weight))
Possible Hyperparameters:

| | |
|---|---|
| Bias | = [True, False] |
| InputChannels | = int |
| OutputChannels | = int |

As shown, the hyper-parameters of the higher-level layers (e.g., with_bias or no_bias), translate into separate instructions (add( . . . , Bias) in the low-level IR. Also, in some cases such as the RNN, the bias gets applied within the operation, while for GEMM and convolution (Conv), it is the outermost operation. Most “int” hyper-parameters such as channels are encoded as dimensions. However, “numLayers” and “numSequences” are encoded as entire sub-graphs. In some examples, low-level operators can be used more flexibly than high level operators. While in high level operators, a bias is represented as an addition (e.g., “Output=Input+Bias”). However, in low level IR, it could be “Output=Input−Bias”, which then cannot be directly translated to high level operators, because the instruction does not match. But, “Output=Input+(−Bias)” would match.

Examples for these differences can be seen in FIG. 3A. As mentioned above, the dashed boxes 304 and 306 represent two RNNCells. However, the RNNCell 304 does not have the computational part for HiddenWeight and HiddenBias (e.g., blocks 340 and 346). Still, both can be represented as “RNNCell” in the higher IR, which is shown in FIG. 3B. RNNCell 304 of FIG. 3A becomes the RNNCell block 384 and RNNCell 306 becomes the RNNCell block 386. The second (e.g., RNNCell block 386) has two additional inputs (e.g., the hidden states/blocks 340 and 346), while these are missing for the RNNCell 306. These missing inputs are encoded hyper-parameters of the high level operator. The hyper parameter “numSequences” is hard-coded in the computational graph 382, because it only supports “slice[0]” and “slice[1]”. Therefore, “numSequences” is statically set to 2. With the transformation from two “RNNCell” to one “RNN” layer, this hyper parameter that is hardcoded into the computation graph gets removed from the structure of the graph. This allows the higher IR to use dynamic “numSequences”, because it is no longer fixed into the computation graph.

The computing device 204 performing the detection of higherable layers (e.g., executing the IRs to detect the higherable layers) is described below. The RNN layers (e.g., the RNN layers of FIGS. 3A and 3B) are used as an example as these are the layers with the highest number of hyper-parameters available and a perfect example of explaining one or more embodiments of the invention (e.g., the method of the invention). However, it is noted that the embodiments of the invention can also apply to other layers. In other words, in some embodiments, the computing device 204 performs the detection and/or replacement of higherable layers for RNN layers and/or other layers. For instance, referring to FIG. 3A, the computing device 204 can detect that certain blocks from the RNN Cell 304 and 306 can be consolidated. The computing device 204 can flag these blocks, and then provide replacement of these blocks with a higherable layer (e.g., a higher layer or a layer that is higher on the IRs 208/compiler list) for RNN layers and/or other layers. For instance, the computing device 204 can detect that blocks 314 and 318-336 are able to be consolidated. The computing device 204 can then consolidate these blocks together such as the block 384 (e.g., the RNNCell 384) shown in computational graph 382 of FIG. 3B. Further, the computing device 204 can perform another consolidation such as consolidating blocks 384 and 386 into block 392 of computational graph 390. By consolidating the blocks, certain optimization parameters, functions, algorithms, specialized hardware, and/or libraries (e.g., CUDNN or DNNL) are able to be used. For instance, the computing device 204 uses one or more optimization parameters, functions, algorithms, and/or libraries on the consolidated blocks 384, 386, and/or 392. Therefore, using the detection and replacement of higherable layers, the computing device 204 is able to use optimization techniques that are usable at higher levels of the compiler process for lower levels, which enables significantly faster run-time speed to compile certain codes such as execution of RNNs, reduction of memory/energy usage, and other benefits.

In some instances, a problem for detecting the higher-level layers in the computation graph is that often, hyper-parameters have been translated into the layers themselves. Thus, there are instances where a high variability on layer sequences that all could match. Further, each layer can have in theory an unlimited number of consecutive layers, which increases the complexity of the detection algorithm. Embodiments of the present invention reduces the complexity of the search for potential sub-graphs in multiple steps that are described below. For instance, because of mathematical equivalence (e.g., “output=input+bias” is equal to or the same as “output=bias+input”), embodiments of the present invention check the different combinations for mathematical equivalence.

For instance, at a first step, while the number of layers that use the result of a previous layer is undefined and can in theory be infinitely large, the number of inputs is statically limited by the layer itself (e.g., an Add layer always has two inputs such as “A” and “B” that are Added together). Thus, embodiments of the present invention utilize a bottom-up approach to serialize sub-graphs. So, embodiments of the present invention can parse through the graph and when a layer is detected, that is potentially an end-node of a high-level layer, then reverse parsing is performed, and the method moves upwards. For instance, higher level layers usually end with a specific operation. For example, a “Conv(bias=True)” layer always has an “Add” operation at the end. So, if it is desired to find “Conv(bias=True)” layers, embodiments of the present invention can search for “Add” because without it, it would never match “Conv(bias=True)”.

For example, the computing device 204 parses through the computational graph (e.g., computational graph 300) such as analyzing one or more blocks (e.g., each block) of the computational graph. During the parsing, the computing device 204 can detect a layer (e.g., a higherable layer) and/or an end-node of a high-level layer. Based on this detection, the computing device 204 can perform reverse parsing (e.g., moving upwards). For instance, the computing device 204 can detect an end-node of a high-level layer such as Mul 336 or an Add operation for “Conv(bias=True)” layers. Based on detecting the end-node, the computing device 204 can perform reverse parsing (e.g., moving up from Mul 336 to Tanh 334 and Sigmoid 330, and so on).

At a second step, during this upward parsing, embodiments of the present invention check which layers that are being traversed and abort when layers are passed that cannot be part of the high-level layer, or if the number of that layer-type that could be part of the high-level layer is exceeded. For example, during the reverse or upwards parsing, the computing device 204 checks (e.g., determines) the layers that are being traversed and aborts (e.g., stops) when layers are passed that cannot be part of the high-level layer. Additionally, and/or alternatively, the computing device 204 stops based on the number of that layer-type exceeding a threshold (e.g., a maximum possible of layer threshold indicating a maximum number of layers that can be part of the higher-level layer).

For instance, embodiments of the present invention can start with “Mul” block 378 of dashed box 306, and move upwards. Embodiments of the present invention understands that a LSTM can only include GEMM, Add, Mul, Tanh, Sigmoid, and Slice operations. So by traversing the computational graph 300 upwards, as soon any other operation is found, it is impossible to match that with a LSTM. However, if only these operations are found. the sub-graph (e.g., the sub-graph associated with box 306) can be extracted and then, in the third step, a thorough matching is performed. In other words, a coarse matching algorithm is performed. First, sub-trees are found that include only the necessary instructions. This is very efficient because embodiments of the present invention do not need to check the actual structure of the graph. Once the sub-graphs are determined, a third step is performed, which then checks the actual structure of the sub-graph and checks whether the sub-graph matches any higher level operators that are available. In other words, the computing device 204 obtains information indicating that a particular higher operation (e.g., LSTM) includes only certain operations (e.g., GEMM, Add. Mul, Tanh, Sigmoid, and Slice operations). When traversing upwards, the computing device 204 checks the layers that are being traversed and aborts when layers are passed that cannot be part of the high-level layer (e.g., finding operations that are not GEMM, Add, Mul, Tanh, Sigmoid, and/or Slice operations). However, if only these operations are found and the number of layers does not exceed a threshold, then the computing device 204 determines that the sub-graph can be extracted (e.g., the sub-graph is a LSTM).

At a third step, after detecting a potential sub-graph (e.g., after determining to abort), embodiments of the present invention perform a more thorough checking. This is used for example, if the structure and low-level layers used in LSTM-, GRU-and SimpleRNN-Cells are identical, and it depends on how these are connected internally. This detection itself depends on the underlying function and can be implemented in different ways.

For example, at this point, a subgraph (e.g., layers from 336 to 302) is determined. The subgraph includes Slice, Add, GEMM, Sigmoid, Tanh and Mul operations. Thus, this can be any type of RNN (e.g., SimpleRNN, linear before reset (LBR) gated recurrent unit (GRU) or (LBR) GRU, and/or LSTM) or another type of higher level operation. The sub-graph is traversed upwards starting from Mul 336. When ADD 318 is reached, four activation functions (e.g., Sigmoid and Tanh) are passed and thus (LBR) GRU and Simple RNN can be excluded because the structure does not match their computations. Continuing upwards, an ADD 318 and GEMM 314 are traversed, which are the two missing pieces for a LSTM. Now, given there are only three slices and only 1 GEMM, embodiments of the present invention can determine that this is a LSTM without hidden-state input. Further, because of the ADD 318 after the GEMM, this is a LSTM with bias. Thus, these are the hyper parameters of the layer that are encoded in the computational graph. Other hyperparameters can include the number of channels, which are encoded within the sizes of the tensors. They are not shown in FIG. 3A merely to simplify the complexity of the computational of graph 300, but can be included and traversed by embodiments of the present invention. In other words, at the third step, the computing device 204 performs a more thorough checking of the potential sub-graph. For instance, the computing device 204 can determine a traversed structure for a potential sub-graph based on counting the number and/or types of layers being passed when traversing the sub-graph. The computing device 204 can then exclude certain higherable operations if the traversed structure does not match the computations (e.g., the structure of the higherable operations). For example, based on counting four activation functions, the computing device 204 determines that (LBR) GRU and Simple RNN can be excluded because the structure does not match their structure. Then, based on counting only certain other blocks (e.g., three slices and 1 GEMM), the computing device 204 determines the particular higherable operation (e.g., LSTM without hidden-state input and with bias). For instance, the computing device 204 determines a higher level layer for the sub-graph based on the traversed structure matching the structure for the higher level layer and/or the hyperparameters (e.g., the ADD 318 after the GEMM or the three slices and only 1 GEMM).

For instance, for convolution, a graph matching can be: “[add\(]?fold\(mul\(unfold\((\T), (\T)\)\)[, (\T)\)]?”. The above shows a regex syntax and use “\T” for a pattern that matches tensor. If this matches, it can have 2 or 3 sub-matches. In case of 2, it's a convolution without bias and in case of 3, it's with bias. After, at the fourth step, embodiments of the present invention can then disconnect and delete the sub-graph, and create the new high-level layer with the gathered hyperparameters and insert it into the place where the sub-graph had been before.

For instance, the computing device 204 detects type and hyperparameters of higherable operation within the extracted sub-graphs, and/or replaces sub-graphs in-place with highered layers. For instance, after detecting and/or identifying a sub-graph, the computing device 204 performs a more thorough checking of the detected sub-graph such as determining how the blocks (e.g., layers) are connected internally. Based on the thorough checking. the computing device 204 detects the type and hyperparameters of the higherable operation within the extracted sub-graphs. After, the computing device 204 disconnects and deletes the sub-graph (e.g., the blocks of the sub-graph), and creates a new high-level layer with the gathered hyperparameters and inserts it into place where the sub-graph had been before. For instance, referring to FIGS. 3A and 3B and the transition shown by arrow 380, the computing device 204 disconnects and deletes the first and second dashed boxes 304 and 306. The computing device 204 then creates a new high-level layer (e.g., the RNNCells 384 and 386 of the computational graph 382) with the gathered hyperparameters, and inserts the new high-level layer (e.g., the RNNCells 384 and 386) into the place where the sub-graph had been before. Therefore, the computing device 204 generates the computational graph 382. The computing device 204 can perform this process one or more times. For instance, the computing device 204 can re-perform this process to generate the computational graph 390 by replacing blocks 384 and 386 with block 392. After this transformation (e.g., the replacements), the computing device 204 performs one or more optimization techniques. In other words, the computing device 204 detects one or more types of higherable operations associated with the extracted sub-graphs (e.g., higherable operations indicated by the extracted sub-graphs) and/or hyperparameters within the extracted sub-graphs (e.g., operations that can be decomposed into lower-level instructions). The higherable operations are associated with a higher level layer that can replace the extracted sub-graphs (e.g., the higherable operations indicate a higher level layer that can replace the extracted sub-graphs). The computing device 204 replaces the extracted sub-graphs with the higher level layers.

In some instances, in embodiments of the present invention with IRs that group operations or use namespaces (e.g., TENSORFLOW graph), this additional information can be used to further simplify the process, as the subgraphs that are being looked for are usually within the same namespace.

In some embodiments, problems can occur during the highering of IR process that is described above. For instance, one issue of the “highering” is that many operations can be represented in mathematically equivalent forms. For instance, operations such as tanh can be represented directly as tanh operator, or by any of their mathematical equivalent formulas:

$$tanh x = \frac{sinh x}{cosh x} = \frac{{e}^{x} - {e}^{- x}}{{e}^{x} + {e}^{- x}} = \frac{{e}^{2 x} - 1}{{e}^{2 x} + 1} = 1 - \frac{2}{{e}^{2 x} + 1}$$

To solve this, embodiments of the present invention first transform basic operations that do not inherit from other higherable methods, so that more complex high-level operators such as RNN do not need to check for all different kinds of implementations that sub-operations could be represented in.

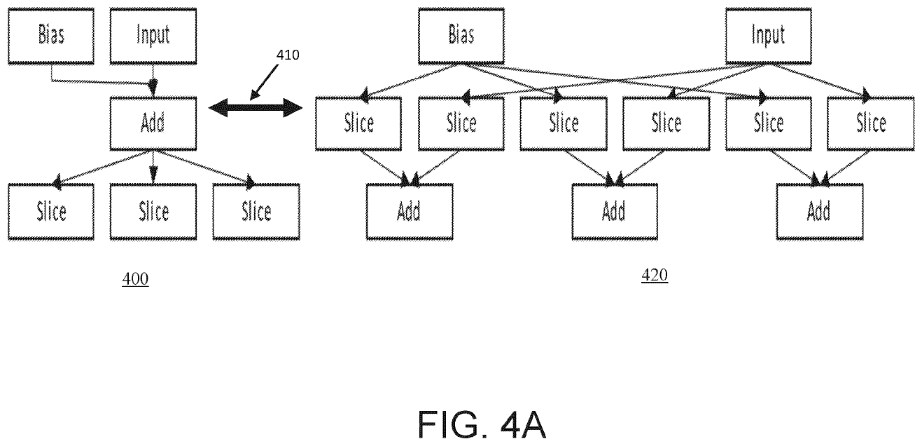

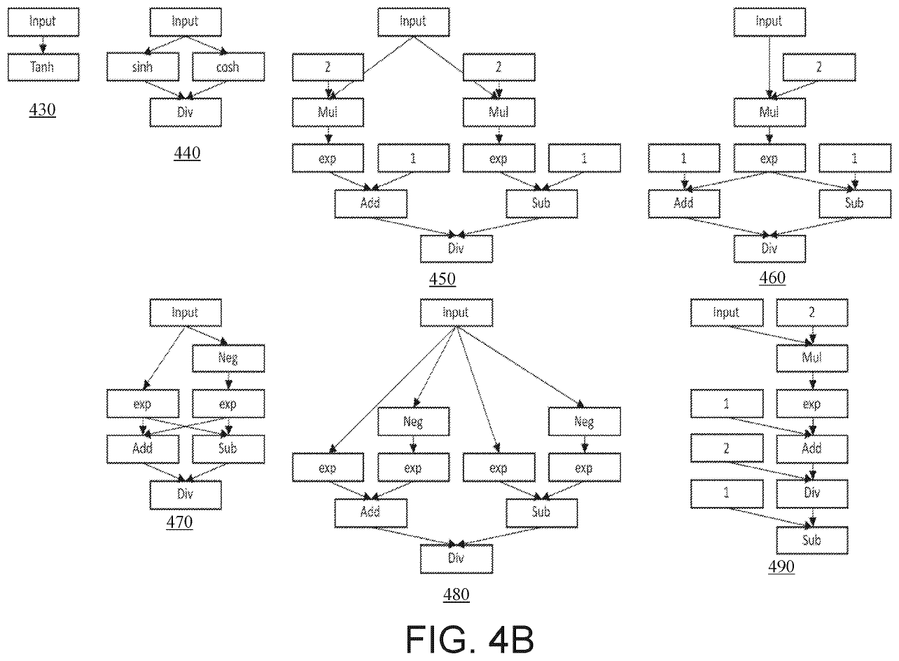

Cases such as Add or Mul, which are substitutable (e.g., A+B=B+A) however cannot be predetermined beforehand and embodiments of the present invention need to specifically handle these when detecting the higher level layers. The same applies for computations graphs as shown in FIG. 4A, that either do the slicing before, or after being added together (e.g., this kind of computation can occur within RNN layers). FIG. 4A shows an example for mathematically equivalent subgraphs according to an embodiment of the present invention. For instance, FIG. 4A shows computational subgraphs 400 and 420. The arrow: 410 denotes that the subgraphs 400 and 420 are mathematically equivalent.

For example, this can be performed before the part of the detection of sub-graphs (e.g., prior to step 1 above). For instance, referring to FIG. 4B, computational graphs 430-490 show different versions of “Tanh”. These graphs 430-490 are mathematically all equivalent. But, as shown in FIGS. 3A and 3B, here “Tanh” is used. Looking for all of these possible “Tanh” variables can be inefficient. Therefore, a repeating approach (e.g., transforming basic operations) is performed. For instance, if the computational graph 490 of “Tanh” is within computational graph 300, embodiments of the present invention can detect this (e.g., “1−(2/exp(2×)+1))” as the Tanh and would replace it with Tanh. Then, the process is repeated, in which RNNCells are detected (e.g., computational graph 300 to 382). Then, the process is repeated and an RNN is detected (e.g., computational graph 382 to 390). The process is repeated until no higherable layers are able to be detected anymore (e.g., similar to “Recursive Highering”).

In-place versus out-of-place highering is described below. For instance, in some embodiments, depending on the IR, specific high-level operators are not available (e.g., TENSORFLOW graphs do not support RNN layers). Therefore, embodiments of the present invention can convert the source IR to another destination IR that supports these kinds of operators. In such embodiments, first, the computing device 204 performs the previously described detection (e.g., steps one and/or two). Then, the computing device 204 starts parsing the source IR. Whenever a layer is hit that has been flagged to be higherable, the computing device 204 instead creates a new instance of high-level layer and skips over all highered layers within the source IR.

In contrast, in the in-place highering. the computing device 204 removes all layers of the subgraph and replaces it with the highered layer. However, in some instances, a disadvantage of in-place highering can be encountered. For instance, RNNs encode their hyper parameter “sequence length” as separate layers within the subgraph. If the IR does not support loop primitives, or the user enforced to unroll the RNN (e.g., through the Keras parameter “unroll”), the sequence length gets encoded as fixed value within the computation graph, which might not be desired. Out-of-place highering has the advantage, that it rebuilds the computation graph from front to back. So, the outputs of newly created high-level operators can be marked as “variable”, which then gets propagated through-out the remaining graph while it gets translated from the source to the destination IR.

For instance, in-place highering allows for higher layers within the same IR. This requires that the IR supports the lower and higher level operators. The steps are the same as described above (e.g., step 1: detect possible subgraphs: step 2: match lower to higher level operators: step 3: delete subgraphs: step 4: insert higher level operator: step 5: repeat until nothing changes anymore).

Out-of-place highering translates the source IR into a destination IR while highering. This is necessary when the source IR does not support the higher level operators. Here, two methods are used to perform this. The first method translates the source to destination IR, and then the in-place highering on the destination IR is performed. As described, this method can have the negative impact, that some hyper parameters (e.g., numSequences) is encoded into the structure of the graph itself. Therefore, it is fixed. When highering the operation, this can be identified and made dynamic. So instead of (RNNCell>RNNCell>RNNCell (numSequences==3)), a single (RNN) layer can be used, that then internally uses a loop to do as many sequences as needed. However, when the entire graph is translated to the destination IR first, the graph inherits the fixed number of sequences. Therefore, to make it “dynamic” again, a post processing step is used, that traverses over the entire graph to make the “sequences” dimension dynamic in all other layers. This is not only a lot of work, but also very error prone. In other words, such a propagation could also be implemented for an in-place highering, however this can be more complicated and error prone to implement.

Therefore, “out-of-place” highering is used. Here, possible subgraphs in the source IR are identified. Then, the source IR is translated to destination IR top-down. When one of the identified sub-graphs is reached, the “third step” above is performed to see if this sub-graph is really higherable. If yes, the highered operator is directly placed into the destination IR. When now continuing translating to the graph, it is known already that the “sequences” is “dynamic”, and can directly use this information, instead of using a post-processing that needs to touch the computation graph.

Embodiments of the present invention provide for the following improvements and advantages over existing computer systems and/or compilers/assemblers/IRs when converting source code to machine code:
1. Simplifying the computation graph, which makes optimizing transformations easier to implement. Further, this can also enable specific mathematical transformations, which otherwise might not be able to be transformed at all.
2. Enabling and/or using optimized high-level operators provided by libraries or specialized hardware (e.g., graphic processing units (GPUs), Vector Processors, field programmable gate arrays (FPGAs), application-specific integrated circuits (ASICs), and so on). By utilizing embodiments of the present invention, the libraries and/or specialized hardware can be utilized, which can easily yield in a speed up of two to four times.
3. Reductions of memory allocations. State-of-the-art runtime systems allocate/free memory for each executed layer. If 20 low-level layers can be highered into 1 high-level layer, this reduces the number of allocations/frees significantly, reducing unnecessary overhead.

One or more embodiments for utilizing highering is described below. However, it is noted that the utilizing of highering can be used for numerous embodiments. For instance, two applications for highering include in runtime systems such as open neural network exchange runtime (ONNXruntime), TensorFlow (TF) TF Runtime, or in just-in-time (JIT-) compiler such as Tensor Virtual Machine (TVM), SOL AI framework by NEC Corporation (“SOL”) (see, e.g., Nicolas Weber, “SOL: Reducing the Maintenance Overhead for Integrating Hardware Support into AI frameworks”, https://www.nec.com/en/global/solutions/hpc/articles/tech20.html, the entire contents of which, are hereby incorporated by reference herein), Neural Network Fuser (NNFuser) or Open Visual Inference and Neural Network Optimization (OpenVINO). These can use IRs as input. Runtime systems (e.g., the computing device 204) directly execute these IRs on demand using different specialized function calls. Compilers translate them into program code, that either gets compiled or uses highly optimized implementations. For the above cases, highering can be used as preprocessing step, to optimize/simplify the IR to better map onto available execution or compilation primitives. For instance, the computing device 204 can utilize the embodiments of the present invention as a preprocessing step, to optimize/simplify the IR to better map onto available execution or compilation primitives.

William Moses et al.: “Polygeist: Raising C to Polyhedral MLIR”, In 2021 30th International Conference on Parallel Architectures and Compilation Techniques (PACT). IEEE. https://doi.org/10.1109/pact52795.2021.00011.

The technical fields and/or uses of the embodiments of the present invention are described below.

For instance, in some examples, embodiments of the present invention are used for unsupported high-level operators. For example, as mentioned above, embodiments of the present invention can be used for problems within TENSORFLOW Graph that has no native operators available to support high-level RNN operators. Therefore, using traditional methods, it is impossible to map these onto highly optimized compute libraries. Using embodiments of the present invention, the computing device 204 enables the recovery of the high-level operators from the low-level TENSORFLOW Graph implementation and for example translate into an IR that supports these (e.g., TORCHSCRIPT or open neural network exchange (ONNX)) to enable such optimizations. One example pipeline can be TensorFlow to (e.g., “->”) ONNX to (e.g., “->”) ONNXruntime, which allows for the computing device 204 to execute the TENSORFLOW RNN model much more efficiently due to the optimized RNN implementation that then can be used.

In some variations, embodiments of the present invention are used for cross-domain and cross-framework operator optimization. For instance, with the increasing number of domain specific languages and frameworks, it can be seen that users want to mix functionalities or methods of different scientific domains, within their own framework and language of choice.

For example, the programming language JULIA is aiming at high performance within scientific computing but has not natively been designed for artificial intelligence (AI). However, the Flux Package enables to do AI tasks within JULIA. As JULIA itself does not have support for these AI layers within its native IR, they use low-level operators (see, e.g., https://github.com/FluxML/Flux.jl/blob/master/src/layers/recurrent.jl, the entire contents of which, are hereby incorporated by reference herein).

Using embodiments of the present invention, the computing device 204 implements compilers and/or runtime-systems that parse IR from any kind of source, detect layers that are implemented using low-level operators, and transform them into higher-level operators to achieve much better performance.

Embodiments of the present invention especially affects new domains that “jump onto” the AI train, such as biomedical or physical simulation, where the established domain-specific language (DSLs) and frameworks don't provide such mechanisms. For instance, both areas (e.g., physical simulation and biomedical) are emerging fields. In physics simulation, the goal of artificial intelligence (AI) is to replace very expensive computations, which approximated AI models (e.g., for chemical reactions, the parameters of the environment such as pressure, temperature, and so on that influence the outcome of these reactions, and therefore need to be constantly recomputed). Scientists can try to replace the costly computations with AI models that provide similar/more accurate results within shorter time. The same can be performed for biomedical computations such as multi-sequence alignment, which is a widely used method to match ribonucleic acid (RNA)/deoxyribonucleic acid (DNA) sequences and to see how familiar different strains are to each other (see e.g., https://en.wikipedia.org/wiki/Multiple_sequence_alignment, which is incorporated by reference herein in its entirety). The more sequences that one can have, the more computational demanding the matching is, because all sequences will need to be compared against all other sequences. With AI, scientists try to find better methods that allow better/faster sequence alignments. Also, these alignments are based on weighting matrix (e.g., Blocks Substitution Matrix (BLOSUM)) that describe the likelihood that one amino acid gets substituted with another through genetic mutation. AI is also used to improve these kind of matrices.

In some instances, embodiments of the present invention are used for cases such as TENSORFLOW, which does not support RNN layers within its TENSORFLOW Graph (TFGraph) IR. This results in very poor performance in TENSORFLOW in comparison to other frameworks.

In some examples, embodiments of the present invention have been implemented and compared to traditional methods. By using embodiments of the present invention, such as using the embodiments of the present invention for SOL for a TENSORFLOW RNN, it was determined that the speedup to the TENSORFLOW RNN in inference by a factor of approximately 17 times and saved approximately 8 times the energy compared to TENSORFLOW. For other areas that use even larger RNN networks, it was determined that using embodiments of the present invention had a speedup of approximately 50 times compared to TENSORFLOW. This may be because the larger RNN networks use very long sequence lengths (e.g., greater than 200), which results in over 200 RNN Cells per RNN layer, which again produce more than 10 layers per RNN Cell. Thus, their NN runs over 2000 layers in TENSORFLOW, which is replaced by embodiments of the present invention with a single RNN layer within SOL.

Embodiments of the present invention provide for the following improvements over existing technology:
1. Highering low-level operators and recovering their hyper-parameters from the IR's graph structure to map these onto highly optimized high-level operator implementations.
2. Using a bottom-up graph parsing to reduce the complexity of looking for potential sub-graphs.
3. Using a coarse sub-graph search algorithm, that only matches layers, and in a second pass determines the highered operation, to reduce search complexity.
4. Translate the source IR out-of-place into an IR with more high level operator support, to enable highering for source IR's with limited operator support.

In an embodiment, the present invention provides a method for using a low-level IR as input, and storing it either in the same IR (in-place) or another IR (out-of-place). The method comprises the steps of:
1. Preprocess source IR (e.g., a first IR) and identify sub-graphs that could match high-level layers using bottom-up search.
2. Detect type and hyperparameters of higherable operation within the extracted sub-graphs. For instance, this is shown in FIGS. 3A and 3B. For example, in box 304, an LSTMCell with Bias (e.g., blocks 316 and 318), but without a hidden state is shown. In box 306, a LSTMCell with Bias (e.g., blocks 348 and 316 as well as 350 and 346) and with hidden states (e.g., blocks 344 and 340) is shown. Other hyper-parameters are the sequence length. For instance, in computational graph 382, two RNNCells are shown so the sequence length is two.
3. Replace sub-graphs in-place with highered layers.

Furthermore, the method can also include the optional step of during translating the source IR to destination IR (out-of-place), replace sub-graphs with highered layers.

For example, the computing device 204 detects one or more types or one or more hyperparameters within one or more extracted sub-graphs. The one or more extracted sub-graphs are part of a computational graph associated with a first intermediate representation (IR) during a compiling process for converting source code to machine code. The computing device 204 replaces the one or more extracted sub-graphs with one or more higher level layers to generate a new computational graph.

The compiling process comprises sequentially using each of a plurality of IRs one after another to convert the source code to the machine code. For instance, as mentioned above, the computing device 204 converts the source code 202 to the machine code 210 using a plurality of IRs. At each stage of the conversion, the computing device 204 determines a new IR (destination IR) from a source IR (e.g., the first IR), which is from a previous execution of the IR. The one or more highered layers is associated with a second IR that is sequentially before the first IR within the plurality of IRs. For instance, the second IR is closer to the source code 202 than the first IR.

The computing device 204 preprocesses the first IR to identify the one or more extracted sub-graphs that indicate the one or more higher level layers based on using a bottom-up search, which includes parsing through the computational graph to detect a potential higher level layer or an end-node of a higher level layer: and performing reverse parsing of the computational graph based on detecting the potential higher level layer or the end-node.

The computing device 204 aborts the reverse parsing based on passing a layer that cannot be part of the higher level layer or aborting the reverse parsing based on comparing a number of layers parsed during the reverse parsing and a maximum possible of layer threshold.

The computing device 204 applies one or more optimization techniques to the one or more higher level layers of the new computational graph to facilitate the compiling process for converting the source code to the machine code. For instance, the specialized hardware might not be able to use the computational graph associated with the first IR, but is able to use the new computational graph based on replacing the one or more extracted sub-graphs with the one or more higher level layers.

The computing device 204 replaces the one or more extracted sub-graphs with the one or more higher level layers to generate the new computational graph by during translating the first IR to a destination IR, replacing the one or more extracted sub-graphs in place or out-of-place with the one or more higher level layers to generate the new computational graph.

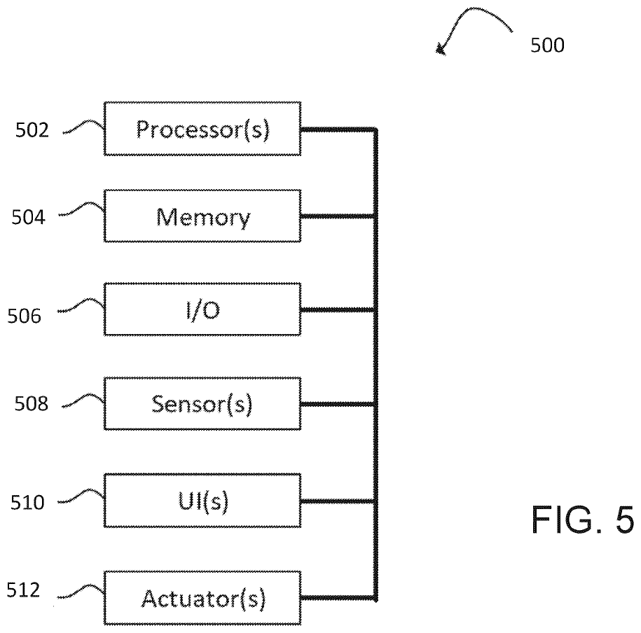

FIG. 5 is a block diagram of an exemplary processing system, which can be configured to perform any and all operations disclosed herein. Referring to FIG. 5, a processing system 500 can include one or more processors 502, memory 504, one or more input/output devices 506, one or more sensors 508, one or more user interfaces 510, and one or more actuators 512. Processing system 500 can be representative of each computing system disclosed herein.

Processors 502 can include one or more distinct processors, each having one or more cores. Each of the distinct processors can have the same or different structure. Processors 502 can include one or more central processing units (CPUs), one or more graphics processing units (GPUs), circuitry (e.g., application specific integrated circuits (ASICs)), digital signal processors (DSPs), and the like. Processors 502 can be mounted to a common substrate or to multiple different substrates.

Processors 502 are configured to perform a certain function, method, or operation (e.g., are configured to provide for performance of a function, method, or operation) at least when one of the one or more of the distinct processors is capable of performing operations embodying the function, method, or operation. Processors 502 can perform operations embodying the function, method, or operation by, for example, executing code (e.g., interpreting scripts) stored on memory 504 and/or trafficking data through one or more ASICs. Processors 502, and thus processing system 500, can be configured to perform, automatically, any and all functions, methods, and operations disclosed herein. Therefore, processing system 500 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 500 can be configured to perform task “X”. Processing system 500 is configured to perform a function, method, or operation at least when processors 502 are configured to do the same.

Memory 504 can include volatile memory, non-volatile memory, and any other medium capable of storing data. Each of the volatile memory, non-volatile memory, and any other type of memory can include multiple different memory devices, located at multiple distinct locations and each having a different structure. Memory 504 can include remotely hosted (e.g., cloud) storage.

Examples of memory 504 include a non-transitory computer-readable media such as RAM, ROM, flash memory, EEPROM, any kind of optical storage disk such as a DVD, a Blu-Ray R disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 504.

Input-output devices 506 can include any component for trafficking data such as ports, antennas (i.e., transceivers), printed conductive paths, and the like. Input-output devices 506 can enable wired communication via USBR, Display PortR, HDMIR, Ethernet, and the like. Input-output devices 506 can enable electronic, optical, magnetic, and holographic, communication with suitable memory 504. Input-output devices 506 can enable wireless communication via WiFi®, Bluetooth®, cellular (e.g., LTER, CDMAR, GSMR, WiMax®, NFC®), GPS, and the like. Input-output devices 506 can include wired and/or wireless communication pathways.

Sensors 508 can capture physical measurements of environment and report the same to processors 502. User interface 510 can include displays, physical buttons, speakers, microphones, keyboards, and the like. Actuators 512 can enable processors 502 to control mechanical forces.

Processing system 500 can be distributed. For example, some components of processing system 500 can reside in a remote hosted network service (e.g., a cloud computing environment) while other components of processing system 500 can reside in a local computing system. Processing system 500 can have a modular design where certain modules include a plurality of the features/functions shown in FIG. 5. For example, I/O modules can include volatile memory and one or more processors. As another example, individual processor modules can include read-only-memory and/or local caches.

The following is also incorporated by reference herein in its entirety:
Chris Lattner et al.: “MLIR: A Compiler Infrastructure for the End of Moore's Law”, arXiv: 2002.11054v2, 2020.
William Moses et al.: “Polygeist: Raising C to Polyhedral MLIR”, In 2021 30th International Conference on Parallel Architectures and Compilation Techniques (PACT). IEEE. https://doi.org/10.1109/pact52795.2021.00011.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for intermediate representation highering, comprising:
detecting one or more types of higherable operations associated with one or more extracted sub-graphs or one or more hyperparameters within the one or more extracted sub-graphs, wherein the one or more extracted sub-graphs are part of a computational graph associated with a first intermediate representation (IR) during a compiling process for converting source code to machine code; and
replacing the one or more extracted sub-graphs with one or more higher level layers indicated by the higherable operations to generate a new computational graph.

2. The method of claim 1, wherein the compiling process comprises sequentially using each of a plurality of IRs one after another to convert the source code to the machine code, wherein the one or more higher level layers is associated with a second IR that is sequentially before the first IR within the plurality of IRs during the conversion from the source code to the machine code.

3. The method of claim 1-er 2, further comprising:
preprocessing the first IR to identify the one or more extracted sub-graphs that indicate the one or more higher level layers based on using a bottom-up search.

4. The method of claim 3, wherein preprocessing the first IR to identify the one or more extracted sub-graphs that indicate the one or more higher level layers comprises:
parsing through the computational graph to detect a potential higher level layer or an end-node of the potential higher level layer; and
performing reverse parsing of the computational graph based on detecting the potential higher level layer or the end-node.

5. The method of claim 4, wherein preprocessing the first IR to identify the one or more extracted sub-graphs that indicate the one or more higher level layers comprises:
aborting the reverse parsing based on passing a layer that cannot be part of the potential higher level layer; or
aborting the reverse parsing based on comparing a number of layers parsed during the reverse parsing and a maximum possible of layer threshold.

6. The method of claim 1, wherein detecting the one or more types of higherable operations associated with one or more extracted sub-graphs or the one or more hyperparameters within the one or more extracted sub-graphs comprises:
determining a traversed structure for a sub-graph, of the one or more extracted sub-graphs, based on counting a number and type of layers being passed when traversing the sub-graph; and
excluding one or more second higherable operations based on the traversed structure of the sub-graph not matching structures for the one or more second higherable operations.

7. The method of claim 6, wherein detecting the one or more types of higherable operations associated with the one or more extracted sub-graphs or the one or more hyperparameters within the one or more extracted sub-graphs comprises:
determining a higher level layer, of the one or more higher level layers, for the sub-graph based on the traversed structure of the sub-graph matching the structure for the one or more types of higherable operations and/or the one or more hyper-parameters passed when traversing the sub-graph.

8. The method of claim 1, further comprising:
applying one or more optimization techniques to the one or more higher level layers of the new computational graph to facilitate the compiling process for converting the source code to the machine code.

9. The method of claim 8, wherein the one or more optimization techniques comprises using specialized hardware and/or one or more optimization libraries.

10. The method of claim 9, wherein the specialized hardware is unable to use the computational graph associated with the first IR, and wherein based on replacing the one or more extracted sub-graphs with the one or more higher level layers, the specialized hardware uses the new computational graph during the compiling process.

11. The method of claim 1, wherein replacing the one or more extracted sub-graphs with the one or more higher level layers to generate the new computational graph comprises:
during translating the first IR to a destination IR, replacing the one or more extracted sub-graphs in place with the one or more higher level layers to generate the new computational graph.

12. The method of claim 1, wherein replacing the one or more extracted sub-graphs with the one or more higher level layers to generate the new computational graph comprises:
during translating the first IR to a destination IR, replacing the one or more extracted sub-graphs out-of-place with the one or more higher level layers to generate the new computational graph.

13. The method of claim 1, further comprising:
prior to detecting the one or more types of higherable operations associated with one or more extracted sub-graphs or the one or more hyperparameters within the one or more extracted sub-graphs, transforming basic operations within the computational graph associated with the first IR.

14. A system for intermediate representation highering, the system comprising one or more hardware processors, which, alone or in combination, are configured to provide for execution of the following steps:
detecting one or more types of higherable operations associated with one or more extracted sub-graphs or one or more hyperparameters within the one or more extracted sub-graphs, wherein the one or more extracted sub-graphs are part of a computational graph associated with a first intermediate representation (IR) during a compiling process for converting source code to machine code; and
replacing the one or more extracted sub-graphs with one or more higher level layers indicated by the higherable operations to generate a new computational graph.

15. A tangible, non-transitory computer-readable medium having instructions thereon which, upon being executed by one or more processors, alone or in combination, provide for execution of a method for intermediate representation highering comprising the following steps:
detecting one or more types of higherable operations associated with one or more extracted sub-graphs or one or more hyperparameters within the one or more extracted sub-graphs, wherein the one or more extracted sub-graphs are part of a computational graph associated with a first intermediate representation (IR) during a compiling process for converting source code to machine code; and
replacing the one or more extracted sub-graphs with one or more higher level layers indicated by the higherable operations to generate a new computational graph.
